(19) United States
(12) Patent Application Publication
(10) Pub. No.: US 2024/0256119 A1
(43) Pub. Date: Aug. 1, 2024

(54) METHOD FOR IDENTIFYING OPERATION, AND ELECTRONIC DEVICE, AND COMPUTER READABLE MEDIUM THEREOF

(71) Applicant: NETEASE (HANGZHOU) NETWORK CO., LTD., Hangzhou, Zhejiang (CN)

(72) Inventors: Jieqi XIE, Hangzhou, Zhejiang (CN); Jie CHEN, Hangzhou, Zhejiang (CN)

(73) Assignee: NETEASE (HANGZHOU) NETWORK CO., LTD., Hangzhou, Zhejiang (CN)

(21) Appl. No.: 18/563,415

(22) PCT Filed: Nov. 26, 2021
(86) PCT No.: PCT/CN2021/133539

§ 371 Date: Nov. 22, 2023

(30) Foreign Application Priority Data
May 27, 2021 (CN) 202110584990.8

(51) Int. Cl. G06F 3/04883; G06F 3/0482; G06F 3/0485

(52) U.S. Cl. CPC G06F 3/04883; G06F 3/0482; G06F 3/0485

(57) ABSTRACT

A method for identifying an operation, an electronic device, and a computer readable medium are provided. The method includes: in response to a touch operation acting on a virtual control list, acquiring a state of a touch point corresponding to the touch operation, wherein the virtual control list includes a draggable virtual control icon; acquiring, upon the touch point being in a moving state, a movement angle of the touch point relative to a preset sliding direction of the virtual control list; and determining whether the movement angle of the touch point is greater than a sliding angle threshold, and according to a result of determination of the movement angle, determining an operation type of the touch operation, wherein the operation type includes a slide operation acting on the virtual control list, and a drag operation acting on the virtual control icon.

### CROSS-REFERENCE TO RELATED APPLICATIONS

The present disclosure is a U.S. national phase application of International Application No. PCT/CN2021/133539, filed on Nov. 26, 2021, which is based on and claims priority to Chinese Patent Application No. 202110584990.8, filed on May 27, 2021, titled “OPERATION IDENTIFICATION METHOD AND APPARATUS, ELECTRONIC DEVICE, AND COMPUTER READABLE MEDIUM”, the entire contents of both of which are incorporated herein by reference for all purposes.

### TECHNICAL FIELD

The present disclosure relates to the field of interactive technologies and, in particular, to a method and apparatus for identifying an operation, an electronic device, and a computer-readable storage medium.

### BACKGROUND

In a game, it is often necessary to provide a slidable list to accommodate and display a large number of items or props. For example, in a page such as a store or a backpack, the slidable list can be used to display various skin props or functional props to the player, and more props can be displayed to the player by sliding the list up and down. Such a slidable list solves the problem of displaying a large number of items in a limited area.

For some slidable lists, it is possible to slide up and down to display more props, and it is also possible to drag a prop icon in the list to change the placement of the item.

It should be noted that the information disclosed above in the background section is only intended to enhance the understanding of the background of the present disclosure, and therefore, information that does not constitute the prior art known to those of ordinary skill in the art may be included.

### SUMMARY

The purpose of the present disclosure is to provide a method for identifying an operation, an electronic device, and a computer-readable medium.

According to a first aspect of the present disclosure, a method for identifying an operation is provided, including:
in response to a touch operation acting on a virtual control list in a graphical user interface, acquiring a state of a touch point corresponding to the touch operation, wherein the virtual control list includes a draggable virtual control icon;
acquiring, upon the touch point being in a moving state, a movement angle of the touch point relative to a preset sliding direction of the virtual control list: and
determining whether the movement angle of the touch point is greater than a sliding angle threshold, and according to a result of determination of the movement angle, determining an operation type of the touch operation, wherein the operation type includes a slide operation acting on the virtual control list, and a drag operation acting on the virtual control icon.

According to a second aspect of the present disclosure, an electronic device is provided, including: a processor: and a memory configured to store instructions executable by the processor: wherein the processor is configured to execute the instructions to perform acts including: in response to a touch operation acting on a virtual control list in a graphical user interface, acquiring a state of a touch point corresponding to the touch operation, wherein the virtual control list includes a draggable virtual control icon: acquiring, upon the touch point being in a moving state, a movement angle of the touch point relative to a preset sliding direction of the virtual control list: and determining whether the movement angle of the touch point is greater than a sliding angle threshold, and according to a result of determination of the movement angle, determining an operation type of the touch operation, wherein the operation type includes a slide operation acting on the virtual control list, and a drag operation acting on the virtual control icon.

According to a third aspect of the present disclosure, there is provided a non-transitory computer-readable medium having stored thereon a computer program which, when executed by a processor, causes the processor to: in response to a touch operation acting on a virtual control list in a graphical user interface, acquire a state of a touch point corresponding to the touch operation, wherein the virtual control list includes a draggable virtual control icon: acquire, upon the touch point being in a moving state, a movement angle of the touch point relative to a preset sliding direction of the virtual control list: and determine whether the movement angle of the touch point is greater than a sliding angle threshold, and according to a result of determination of the movement angle, determine an operation type of the touch operation, wherein the operation type includes a slide operation acting on the virtual control list, and a drag operation acting on the virtual control icon.

It should be understood that both the foregoing general description and the following detailed description are merely exemplary and explanatory and do not limit the present disclosure.

### BRIEF DESCRIPTION OF THE DRAWINGS

The accompanying drawings, which are incorporated in and constitute a part of this specification, illustrate embodiments consistent with the disclosure and together with the description serve to explain the principles of the disclosure. It is obvious that the drawings in the following description only show some of embodiments of the present disclosure, and other drawings may be obtained from these drawings by those of ordinary skill in the art without creative efforts.

FIG. 1 shows a schematic diagram of a list slidable in a vertical direction according to one or more embodiments of the present disclosure.

FIG. 2 shows a schematic diagram of a slidable and draggable list according to one or more embodiments of the present disclosure.

FIG. 3 shows a schematic diagram of system architecture applicable to a method and apparatus for identifying an operation according to one or more embodiments of the present disclosure.

FIG. 4 shows a schematic flowchart of a method for identifying an operation according to one or more embodiments of the present disclosure.

FIG. 5 shows a schematic flowchart of determining an operation type according to a determination result of a movement angle according to one or more embodiments of the present disclosure.

FIG. 6 shows a schematic diagram of a sliding angle threshold according to one or more embodiments of the present disclosure.

FIG. 7 shows a schematic flowchart of acquiring a movement speed of a touch point according to one or more embodiments of the present disclosure.

FIG. 8 shows a schematic flowchart of identifying an operation type according to a movement speed of a touch point according to one or more embodiments of the present disclosure.

FIG. 9 shows a schematic flowchart of a method for identifying an operation according to one or more embodiments of the present disclosure.

FIG. 10 shows a block diagram of an apparatus for identifying an operation according to one or more embodiments of the present disclosure.

FIG. 11 shows a schematic structural diagram of a computer system of an electronic device applicable for implementing the embodiments of the present disclosure.

### DETAILED DESCRIPTION

Embodiments are now described more fully with reference to the accompanying drawings. However, these embodiments may be implemented in a variety of forms and should not be construed as being limited to the examples set forth herein: rather, these embodiments are provided so that the present disclosure will be more comprehensive and complete and will fully convey the concept of the embodiments to those skilled in the art. The features, structures, or characteristics described may be combined in one or more embodiments in any suitable manner. In the following description, numerous specific details are provided to give a full understanding of the embodiments of the present disclosure. However, those skilled in the art will appreciate that the technical solutions of the present disclosure may be practiced by omitting one or more of the specific details, or by using other methods, components, devices, steps, etc. In other instances, well-known technical solutions are not shown or described in detail to avoid becoming the focus of the present disclosure and obscuring aspects of the present disclosure.

Furthermore, the drawings are merely schematic illustrations of the present disclosure and are not necessarily drawn to scale. The same reference numerals in the drawings denote the same or similar parts, and thus repeated descriptions thereof will be omitted. Some of the block diagrams shown in the drawings are functional entities and do not necessarily correspond to physically or logically separate entities. These functional entities may be implemented in software, or in one or more hardware modules or integrated circuits, or in different networks and/or processor devices and/or microcontroller devices.

In a game, it is often necessary to provide a slidable list to accommodate and display a large number of items or props. For example, in a page such as a store or a backpack, the slidable list may be used to display various skin props or functional props to the player, and more props may be displayed to the player by sliding the list up and down. Such a slidable list solves the problem of displaying a large number of items in a limited area.

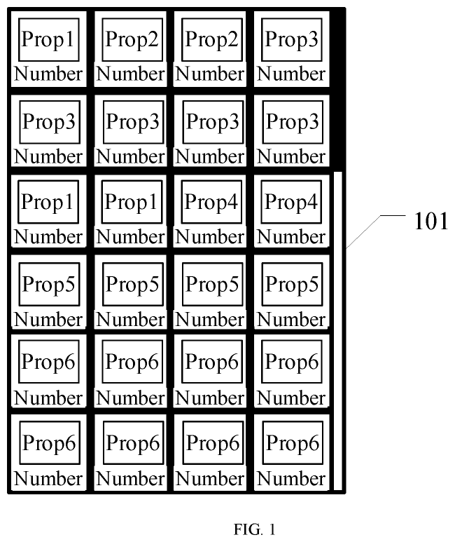

FIG. 1 shows a schematic diagram of a list slidable in a vertical direction according to an embodiment of the present disclosure. There are 24 prop icons displayed in a slidable list 101, and there props may be, for example, bullet-proof vests, bullets and firearms, etc., which are accommodated in the slidable list 101 and are presented to the player in an arrangement shown in the figure. In the slidable list 101 shown in FIG. 1, the visible area may only be accommodated with 24 prop icons, but the player can view more props by sliding the list up and down.

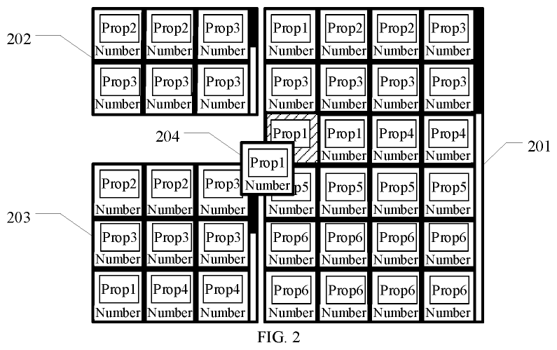

FIG. 2 shows a schematic diagram of a slidable and draggable list according to an embodiment of the present disclosure. There are three slidable lists, including slidable list 201, slidable list 202 and slidable list 203. In addition to sliding these slidable lists up and down to display more prop icons, the icons 204 included in these lists can also be dragged left and right or up and down to change the placement of the props.

Taking the vertically slidable list as an example, although the player would like to be able to not only slide the slidable list up and down, but also drag the prop icon up and down in order to change the placement of the prop, these two operations are in conflict, which requires a suitable standard to determine whether the player wants to drag the icon or slide the list, and thus may result in a poor operation experience.

In some related embodiments, the above problem of the operation conflict may be solved by the following two methods.

1. Determining whether an operation is a drag operation according to touch duration.

The timing starts when the player's finger touches the screen, and if the duration of staying motionless at the same position exceeds a certain threshold, it is determined that the operation is the drag operation: otherwise it is determined as a slide operation.

2. Clicking on an item produces a pop-up window.

After the player clicks an item icon in the list, a detail pop-up window appears, in which the player can specify where he/she wants to place the item.

For the first method in the above related embodiments, using the touch duration to determine the drag operation may, to a certain extent, solve the problem of conflict between drag and slide operations in the vertical direction. However, when facing the demand for rapid dragging, this method cannot meet the requirements and may cause obvious lag in the interactive experience. For example, in a survival gun game, players need to pick up equipment, medicines, and gun accessories, etc. Due to the limited capacity of the backpack, when the game progresses to a very tense stage, it is very important to open the backpack to quickly discard useless items and pick up more useful materials, or quickly replace the gun with various more suitable accessories. At this time, if there is a lag in the drag interaction experience, it may greatly affect the user's gaming experience.

As for the second method of clicking on the item to produce the detail pop-up window; this method may also realize the function of specifying the movement position of the item, and also solve the problem of conflict between drag and slide operations in the vertical direction. However, the disadvantage of this method is that each item has to be clicked twice, and a button is needed to put the item into each area, which is too inefficient for the player to operate. In addition, this method is also unable to cope with the scenario of rapid dragging.

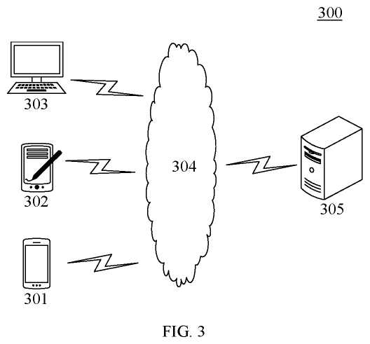

FIG. 3 shows a schematic diagram of system architecture of an application environment applicable to a method and apparatus for identifying an operation according to an embodiment of the present disclosure.

As shown in FIG. 3, the system architecture 300 may include more than one of a mobile terminal 301, a mobile terminal 302, and a mobile terminal 303, as well as a network 304 and a server 305. The network 304 serves as a medium for providing communication links between the mobile terminals 301, 302, 303 and the server 305. The network 304 may include various connection types, such as wireless communication links and the like.

It should be understood that the numbers of mobile terminals, networks and servers in FIG. 3 are only illustrative. There may be any number of mobile terminals, networks, and servers according to implementation requirements. For example, the server 305 may be a server cluster composed of multiple servers.

The mobile terminals 301, 302, 303 may be various electronic devices with processors, including but not limited to smart phones, tablet computers, portable computers and so on. The server 305 may be a server that provides various services. For example, the mobile terminals 301, 302, and 303 may acquire a state of a touch point corresponding to a touch operation through the processor, detect the touch point's dwell touch duration during which the touch point stays at the same position, and acquire a movement angle of the touch point relative to a preset sliding direction of a virtual control list, and acquire a movement speed of the touch point, and then upload the movement angle, movement speed and dwell touch duration of the touch point to the server 305. The server 305 may identify an operation type of the touch operation according to the movement angle, the movement speed and the dwell touch duration of the touch point. The mobile terminals 301, 302, and 303 may also use the processor to complete the entire process from acquiring the state of the touch point corresponding to the touch operation to identifying the operation type of the touch operation.

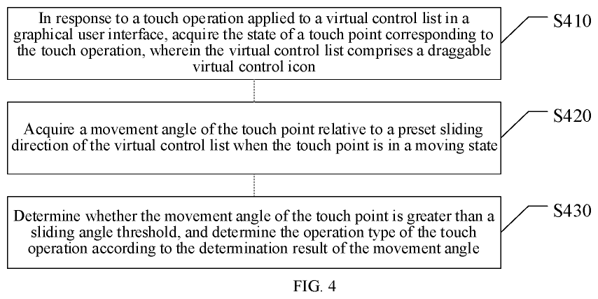

A method for identifying an operation is firstly provided in an embodiment of the present disclosure, which may solve the problem of conflict between drag and slide operations in the above related embodiments, and realize the function of quickly dragging items in the slidable list. Referring to FIG. 4, the method for identifying the operation may include the following steps.

Step S410, in response to a touch operation acting on a virtual control list in a graphical user interface, acquiring a state of a touch point corresponding to the touch operation, wherein the virtual control list includes a draggable virtual control icon.

Step S420, acquiring, upon the touch point being in a moving state, a movement angle of the touch point relative to a preset sliding direction of the virtual control list.

Step S430, determining whether the movement angle of the touch point is greater than a sliding angle threshold, and according to a result of determination of the movement angle, determining an operation type of the touch operation, wherein the operation type includes a slide operation acting on the virtual control list, and a drag operation acting on the virtual control icon.

In the method for identifying an operation of the embodiments of the present disclosure, when the touch point is in the moving state, the movement angle of the touch point relative to the preset sliding direction of the virtual control list is acquired and determined whether it is greater than the sliding angle threshold, thereby identifying whether the operation type of the current touch operation is a slide operation acting on the virtual control list, or a drag operation acting on a virtual control icon in the virtual control list. By means of the method for identifying an operation in the embodiments of the present disclosure, the operation type of the current touch operation can be quickly distinguished and responded to according to the movement angle of the touch point when the user performs a drag operation in approximately the same direction as the sliding direction of the virtual control list, thereby solving the problem of conflict between the drag operation and the slide operation, improving the response accuracy and speed to the operation, realizing the rapid drag operation of the icon, and enhancing the user's operation experience.

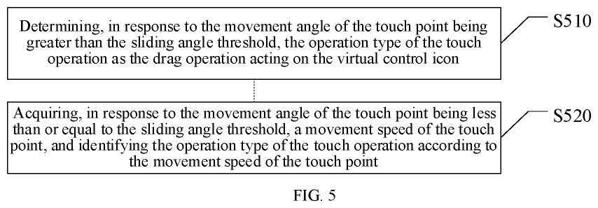

The above steps in FIG. 4 of this embodiment are described in more detail below; in conjunction with FIGS. 5 to 8.

In the step S410, in response to the touch operation acting on the virtual control list in the graphical user interface, and the state of the touch point corresponding to the touch operation is acquired, wherein the virtual control list includes the draggable virtual control icon.

In this embodiment, the virtual control list refers to a slidable list for displaying a large number of virtual controls which may be arranged as icons in the virtual control list. For example, in a game, the virtual controls may include items such as equipment, medicines and gun accessories, as well as skin props or functional props, etc. The virtual control icons in the virtual control list may be dragged to change their placements. The sliding direction of the list may be either up and down or left and right, and in general, the lists that can be slid up and down are more common.

The touch operation refers to a series of operations performed by the user when the user touches the touch screen with a finger. The touch point corresponding to the touch operation refers to a point on the graphical user interface where the user's finger touches the screen.

In terms of game logic, the touch operation of the finger may be divided into touch, move, and release operations. Therefore, in this embodiment, the state of the touch point corresponding to the touch operation may include a touch start state, a moving state and a touch end state. Among them, the touch start state refers to the state of the touch point when the user's finger just contacts the screen: the moving state refers to the state of the touch point when the finger moves on the screen: and the touch end state refers to the state of the touch point when the touch is canceled by the finger or ended normally.

In step S420, the movement angle of the touch point relative to the preset sliding direction of the virtual control list is acquired upon the touch point being in the moving state.

The preset sliding direction of the virtual control list refers to the direction in which the list can be slid. For example, for a list that can be slid up and down, the preset sliding direction is the vertical direction, and accordingly, the movement angle of the touch point relative to the preset sliding direction of the virtual control list is a movement angle of the touch point relative to the vertical direction.

In step S430, it is determined whether the movement angle of the touch point is greater than the sliding angle threshold, and the operation type of the touch operation is determined according to the result of determination of the movement angle, wherein the operation type includes the slide operation acting on the virtual control list, and the drag operation acting on the virtual control icon.

When the touch point is in the moving state, according to the relationship between the movement angle of the touch point and a preset angle threshold, it can be determined whether a slide operation or a drag operation has been performed.

In this embodiment, as shown in FIG. 5, determining the operation type of the touch operation according to the result of the determination of the movement angle may include the following steps.

Step S510, determining, in response to the movement angle of the touch point being greater than the sliding angle threshold, the operation type of the touch operation as the drag operation acting on the virtual control icon.

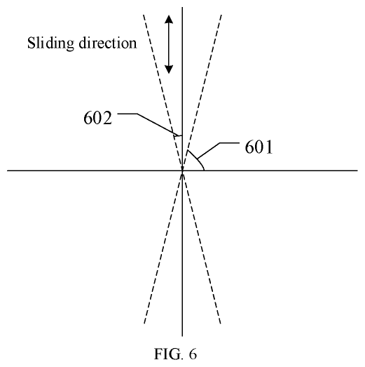

The sliding angle threshold refers to an angle range in which the slide operation conflicts with the drag operation. FIG. 6 shows a schematic diagram of a sliding angle threshold according to an embodiment of the present disclosure. In the schematic diagram, the preset sliding direction of the list is the vertical direction. If the movement angle of the touch point is greater than the sliding angle threshold, e.g., when the movement angle of the touch point is within the range of four obtuse angles 601, the operation within this range may be regarded as a horizontal drag operation, which does not conflict with a vertical slide operation. Therefore, other determination conditions may be ignored directly, and this operation may be directly determined as the drag operation.

Step S520, acquiring, in response to the movement angle of the touch point being less than or equal to the sliding angle threshold, a movement speed of the touch point, and identifying the operation type of the touch operation according to the movement speed of the touch point.

If the movement angle of the touch point is less than or equal to the sliding angle threshold, i.e., when the movement angle of the touch point is within the range of the four acute angles 602 in FIG. 6, the player's operation may be regarded as an operation in the vertical direction, which may cause the problem of conflict between the drag operation and the slide operation. In order to solve the operation conflict within this range, further determination is required in combination with the movement speed and other basis.

As the player slides the list on the phone, it is difficult to ensure that the movement direction of the finger completely coincides with the sliding direction of the list, and there may be some angular deviations. Therefore, for the area wherein there is a conflict between the slide operation and the drag operation, a certain angle range needs to be set aside. As shown in FIG. 6, the angle threshold may be set to a value such as 15° or 20°, and through the test experience in actual operation, 15° is the optimal value for debugging.

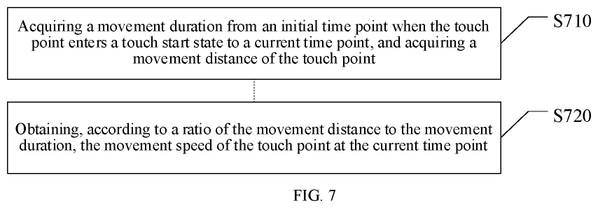

In this embodiment, as shown in FIG. 7, acquiring the movement speed of the touch point may include the following steps.

Step S710, acquiring a movement duration from an initial time point when the touch point enters a touch start state to a current time point, and acquiring a movement distance of the touch point.

An initial position when the touch point enters the touch start state may be acquired, and a current position of the touch point at the current time point may be acquired. Thus, the movement distance of the touch point may be determined according to the initial position point and current position point of the touch point.

For example, when the player presses his/her finger down, the touch point is point A, the position of point A, i.e., Position (A), is fixed, and the time point at this moment is recorded as beginTs. In each frame of the game, if the player does not release his/her finger, the position where the finger slides to is point B, and the time point when the finger slides to the position of point B, i.e., Position (B), is recorded as currentTs. Therefore, the movement distance of the touch point, i.e., the distance between two points A and B, is that: Distance=Position(B)−Position(A), the unit of which is pixel: and the movement duration, i.e., the time taken to move from point A to point B, is that: deltaTs=currentTs−beginTs.

Step S720, obtaining, according to a ratio of the movement distance to the movement duration, the movement speed of the touch point at the current time point.

The moving speed of the touch point at the current time point is that: speed=Distance/deltaTs, the unit of which is pixel per second (pixel/s).

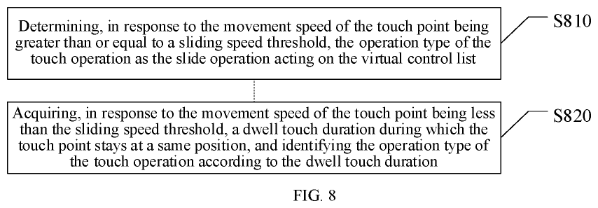

In the area where there is a conflict between the slide operation and the drag operation, the identification of touch operation may be performed by combining the movement angle and speed of the touch point, which can meet the expectations of the player during the actual operation, and thus, whether a drag operation or a slide operation is performed by the player in the area of operation conflict can be determined accurately and quickly. In this embodiment, as shown in FIG. 8, identifying the operation type of the touch operation according to the movement speed of the touch point may include the following steps.

Step S810, determining, in response to the movement speed of the touch point being greater than or equal to a sliding speed threshold, the operation type of the touch operation as the slide operation acting on the virtual control list.

In this embodiment, the movement speed of the touch point in each frame may be calculated in real time, and when the movement speed is greater than a specific threshold, it is directly determined that the current operation is a slide operation. When the movement speed is less than the specific threshold, it is further determined in conjunction with a dwell touch duration during which the touch point stays at the same position in step S820. The sliding speed threshold of 400 pixels per second was tested to be the optimal for player's operation experience.

Step S820, acquiring, in response to the movement speed of the touch point being less than the sliding speed threshold, a dwell touch duration during which the touch point stays at a same position, and identifying the operation type of the touch operation according to the dwell touch duration.

In this example embodiment, when the touch point is in the touch start state, that is, when the user's finger just touches the screen, the dwell touch duration during which the touch point stays at the same position starts to be detected. For example, a timer may be activated upon the touch point entering the touch start state, and the timer is used to detect the dwell touch duration of the touch point during which the touch point stays at the same position.

The dwell touch duration can be used to distinguish whether the player's operation is a drag operation or a slide operation to a certain extent. When the touch duration of the touch point at the same position exceeds a certain threshold, the operation may be directly determined as a drag operation. For example, if the touch duration of the touch point on the same position exceeds 0.1 seconds, the operation is directly determined as a drag operation. The threshold may also be set to, for example, 0.15 seconds, 0.2 seconds, etc. After the tests in actual operation, 0.1 seconds is the optimal value, which can make the player hardly feel the problem of operation lag.

This single determination basis may not enough. In actual operation, the confusion of drag operation and slide operation often occurs. Therefore, it needs to be combined with other determination basis to solve the problem of confusion between drag and slide operations.

In this embodiment, if the dwell touch duration is greater than or equal to a dwell duration threshold, the operation type of the touch operation is determined as the drag operation acting on the virtual control icon: if the dwell touch duration is less than the dwell duration threshold, the movement distance of the touch point is acquired, and whether the operation type of the touch operation is the slide operation acting on the virtual control list is determined according to the movement distance.

In this embodiment, whether the touch operation is the slide operation may be determined according to the relationship between the movement distance and a preset distance threshold. The purpose of this step of detection is to ensure that the statistics of the touch duration are based on the same position or only a very small position change. For example, when the preset distance threshold is 5 pixels, the compatibility of 5 pixels is guaranteed, and once the movement distance exceeds 5 pixels, it is considered that detection of the touch duration is invalid, and the operation is directly determined as the slide operation.

In this embodiment, if the operation type of the touch operation is the slide operation acting on the virtual control list, a movement direction and a movement speed of the touch point are acquired, and the virtual control list is controlled to slide according to the movement direction and movement speed of the touch point.

If the operation type of the touch operation is the drag operation acting on the virtual control icon, a target virtual control icon corresponding to the drag operation is acquired, a corresponding virtual control drag icon according to the target virtual control icon is created, and a display position of the virtual control drag icon is updated in real time according to a position of the touch point. Finally; the final position to which the target virtual control icon is moved is determined according to the position of the finger when it leaves the screen.

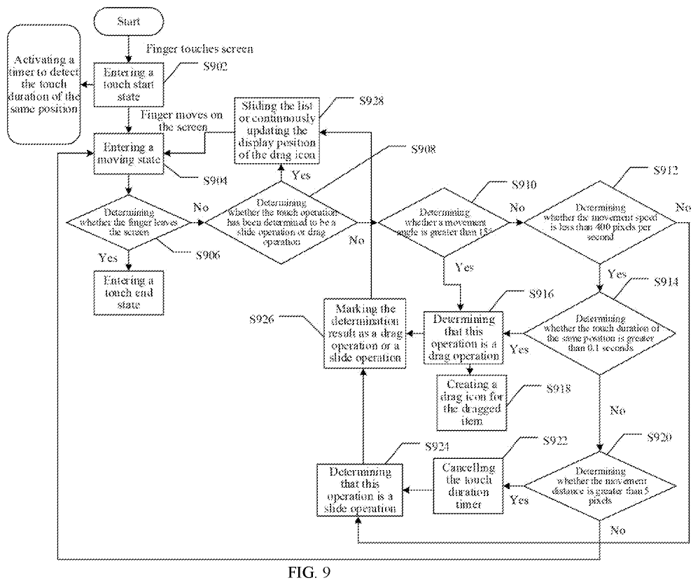

As shown in FIG. 9, it is a complete flowchart of a method for identifying an operation according to an embodiment of the present disclosure, which is an example of the above-mentioned steps in the embodiments of the present disclosure. The steps of the flowchart may be performed by the processor of the mobile terminal 301, 302, or 303, which include as follows.

Step S902, determining that a touch point of a touch operation enters a touch start state.

When the player's finger just touches the screen of the mobile phone, it is determined that the touch point enters the touch start state, and at the same time, according to the determination standard of the touch duration, a timer is activated to detect the touch duration of the touch point at the same position.

Step S904, determining that the touch point enters a moving state.

When the player moves his/her finger on the screen, it is determined that the touch point enters the moving state.

Step S906, determining whether the finger leaves the screen.

After entering the moving state, in each frame in the game, it may detect whether the player releases the finger or not. If the player's finger leaves the screen, it is determined that this operation ends directly and the touch point enters a touch end state. If the player does not release the finger, the subsequent operation identification steps will be proceeded.

Step S908, determining whether the touch operation has been determined to be a slide operation or drag operation.

If the operation has been determined as a drag operation or a slide operation, step S928 will be preceded directly, and according to the determination result, the list will be controlled to slide directly or the icon of the dragged item will be updated continuously. If there is no determination result, identification will be performed according to the algorithmic logic in the subsequent processes.

Step S910, determining whether a movement angle of the touch point is greater than 15°.

If the movement angle is within the range of the obtuse angle 601 shown in FIG. 6, that is, if the movement angle is greater than 15°, it will directly proceed to step $916 to step S918 to determine the current operation as a drag operation, and to create an icon of the dragged item, so that the position of the dragged icon can be updated continuously in future, and the determination result of this operation is marked as a drag operation.

If the movement angle is within the range of the acute angle 602 shown in FIG. 6, that is, if the movement angle is less than 15°, it is determined that the touch point is in the area of operation conflict in the vertical direction of the slidable list, and step S912 will be proceeded to perform further determination according to a movement speed.

Step S912, determining whether the movement speed is less than 400 pixels per second.

If the movement speed exceeds the threshold of 400 pixels per second, step S924 will be proceeded directly to determine the current operation as a slide operation, and the determination result is marked as a slide operation.

If the movement speed does not exceed the threshold of 400 pixels per second, step S914 will be proceeded to perform further determination in combination with the basis of touch duration.

Step S914, determining whether the touch duration of the touch point at the same position is greater than 0.1 seconds.

If the touch duration of the touch point at the same position exceeds 0.1 seconds, step S916 to step S918 will be proceeded to determine the current operation as a drag operation, and to create an icon of the dragged item, so that the position of the dragged icon can be updated continuously in future, and the determination result of this operation is marked as a drag operation.

If the touch duration of the touch point at the same position does not exceed 0.1 seconds, step S920 will be proceeded to further detect whether a movement distance exceeds a certain distance threshold.

Step S916, determining that this operation is a drag operation.

Step S918, creating a drag icon for the dragged item.

Step S920, determining whether the movement distance is greater than 5 pixels.

If this distance threshold is exceeded, it means that the detection of the touch duration is invalid, and this operation is directly determined as a slide operation.

If the movement distance does not exceed the distance threshold of 5 pixels, return to step S904 for a new round of determination.

Step S922, cancelling the touch duration timer.

Step S924, determining that this operation is a slide operation.

Step S926, marking the determination result as a drag operation or a slide operation.

Step S928, controlling the list to slide or continuously updating the display position of the drag icon.

For a slidable list that can be slid vertically, the above method can solve the problem of conflict between the drag operation and the slide operation in the vertical direction. For a slidable list that can be slid horizontally, it is actually a variant of the vertical slidable list, so this solution can also be used to solve the conflict between the drag operation and the slide operation in the horizontal direction.

It should be noted that although the various steps of the methods of the present disclosure are depicted in the drawings in a particular order, it is not required or implied that the steps must be performed in that particular order, or that all of the steps shown must be performed to achieve the desired the results. Additionally or alternatively, certain steps may be omitted, multiple steps may be combined into one step for execution, and/or a single step may be decomposed into multiple steps for execution, etc.

According to some embodiments of the present disclosure, a method for identifying an operation is provided, including:
in response to a touch operation acting on a virtual control list in a graphical user interface, acquiring a state of a touch point corresponding to the touch operation, wherein the virtual control list includes a draggable virtual control icon;
acquiring, upon the touch point being in a moving state, a movement angle of the touch point relative to a preset sliding direction of the virtual control list: and
determining whether the movement angle of the touch point is greater than a sliding angle threshold, and according to a result of determination of the movement angle, determining an operation type of the touch operation, wherein the operation type includes a slide operation acting on the virtual control list, and a drag operation acting on the virtual control icon.

In an embodiment of the present disclosure, determining the operation type of the touch operation according to the result of the determination of the movement angle, includes:
determining, in response to the movement angle of the touch point being greater than the sliding angle threshold, the operation type of the touch operation as the drag operation acting on the virtual control icon; and
acquiring, in response to the movement angle of the touch point being less than or equal to the sliding angle threshold, a movement speed of the touch point, and identifying the operation type of the touch operation according to the movement speed of the touch point.

In an embodiment of the present disclosure, acquiring the movement speed of the touch point includes:
acquiring a movement duration from an initial time point when the touch point enters a touch start state to a current time point, and acquiring a movement distance of the touch point; and
obtaining, according to a ratio of the movement distance to the movement duration, the movement speed of the touch point at the current time point.

In an embodiment of the present disclosure, acquiring the movement distance of the touch point includes:
acquiring an initial position when the touch point enters the touch start state, and acquiring a current position of the touch point at the current time point: and
determining the movement distance of the touch point according to the initial position and the current position of the touch point.

In an embodiment of the present disclosure, identifying the operation type of the touch operation according to the movement speed of the touch point includes:
determining, in response to the movement speed of the touch point being greater than or equal to a sliding speed threshold, the operation type of the touch operation as the slide operation acting on the virtual control list: and
acquiring, in response to the movement speed of the touch point being less than the sliding speed threshold, a dwell touch duration during which the touch point stays at a same position, and identifying the operation type of the touch operation according to the dwell touch duration.

In an embodiment of the present disclosure, identifying the operation type of the touch operation according to the dwell touch duration includes:
determining, in response to the dwell touch duration being greater than or equal to a dwell duration threshold, the operation type of the touch operation as the drag operation acting on the virtual control icon: and
acquiring, in response to the dwell touch duration being less than the dwell duration threshold, a movement distance of the touch point, and determining whether the operation type of the touch operation is the slide operation acting on the virtual control list according to the movement distance.

In an embodiment of the present disclosure, acquiring the dwell touch duration during which the touch point stays at the same position includes:
activating a timer upon the touch point entering a touch start state and detecting, by the timer, the dwell touch duration during which the touch point stays at the same position.

In an embodiment of the present disclosure, the method further includes:
acquiring, in response to the operation type of the touch operation being the slide operation acting on the virtual control list, a movement direction and a movement speed of the touch point, and sliding the virtual control list according to the movement direction and the movement speed of the touch point.

In an embodiment of the present disclosure, the method further includes:
acquiring, in response to the operation type of the touch operation being the drag operation acting on the virtual control icon, a target virtual control icon corresponding to the drag operation: and
creating a corresponding virtual control drag icon according to the target virtual control icon, and updating a display position of the virtual control drag icon in real time according to a position of the touch point.

Embodiments of the present disclosure may have the following beneficial effects.

In the method for identifying an operation of the embodiments of the present disclosure, when the touch point is in the moving state, the movement angle of the touch point relative to the preset sliding direction of the virtual control list is acquired and determined whether it is greater than the sliding angle threshold, thereby identifying whether the operation type of the current touch operation is a sliding operation acting on the virtual control list, or a drag operation acting on a virtual control icon in the virtual control list. By means of the method for identifying an operation in the embodiments of the present disclosure, the operation type of the current touch operation can be quickly distinguished and responded to according to the movement angle of the touch point when the user performs a drag operation in approximately the same direction as the sliding direction of the virtual control list, thereby solving the problem of conflict between the drag operation and the slide operation, improving the response accuracy and speed to the operation, realizing the fast drag operation of the icon, and enhancing the user's operation experience.

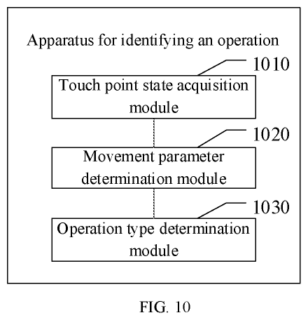

Further, the present disclosure also provides an apparatus for identifying an operation. Referring to FIG. 10, the apparatus for identifying an operation may include a touch point state acquisition module 1010, a movement parameter determination module 1020 and an operation type determination module 1030.

The touch point state acquisition module 1010 is configured to acquire, in response to a touch operation acting on a virtual control list in a graphical user interface, a state of a touch point corresponding to the touch operation, wherein the virtual control list includes a draggable virtual control icon.

The movement parameter determination module 1020 is configured to acquire, upon the touch point being in a moving state, a movement angle of the touch point relative to a preset sliding direction of the virtual control list.

The operation type determination module 1030 is configured to determine whether the movement angle of the touch point is greater than a sliding angle threshold, and according to a result of determination of the movement angle, determine an operation type of the touch operation, wherein the operation type includes a slide operation acting on the virtual control list, and a drag operation acting on the virtual control icon.

In some embodiments of the present disclosure, the operation type determination module 1040 may include a first drag operation determination unit and a movement speed judgment unit.

The first drag operation determination unit is configured to determine, in response to the movement angle of the touch point being greater than the sliding angle threshold, the operation type of the touch operation as the drag operation acting on the virtual control icon.

The movement speed judgment unit is configured to acquire, in response to the movement angle of the touch point being less than or equal to the sliding angle threshold, a movement speed of the touch point, and identify the operation type of the touch operation according to the movement speed of the touch point.

In some embodiments of the present disclosure, the movement speed judgment unit may include a time distance parameter acquisition unit and a movement speed determination unit.

The time distance parameter acquisition unit is configured to acquire a movement duration from an initial time point when the touch point enters a touch start state to a current time point, and acquire a movement distance of the touch point.

The moving speed determination unit is configured to obtain, according to a ratio of the movement distance to the movement duration, the movement speed of the touch point at the current time point.

In some embodiments of the present disclosure, the time distance parameter acquisition unit may include a position point acquisition unit and a movement distance determination unit.

The position point acquisition unit is configured to acquire an initial position when the touch point enters the touch start state, and acquire a current position of the touch point at the current time point.

The movement distance determination unit is configured to determine the movement distance of the touch point according to the initial position and the current position of the touch point.

In some embodiments of the present disclosure, the movement speed determination unit may further include a first slide operation determination unit and a touch duration determination unit.

The first slide operation determination unit is configured to determine, in response to the movement speed of the touch point being greater than or equal to a sliding speed threshold, the operation type of the touch operation as the slide operation acting on the virtual control list.

The touch duration determination unit is configured to acquire, in response to the movement speed of the touch point being less than the sliding speed threshold, a dwell touch duration during which the touch point stays at a same position, and identify the operation type of the touch operation according to the dwell touch duration.

In some embodiments of the present disclosure, the touch duration determination unit may include a second drag operation determination unit and a second slide operation determination unit.

The second drag operation determination unit is configured to determine, in response to the dwell touch duration being greater than or equal to a dwell duration threshold, the operation type of the touch operation as the drag operation acting on the virtual control icon.

The second slide operation determination unit is configured to acquire, in response to the dwell touch duration being less than the dwell duration threshold, a movement distance of the touch point, and determine whether the operation type of the touch operation is the slide operation acting on the virtual control list according to the movement distance.

In some embodiments of the present disclosure, the touch duration determination unit may include a timer activation unit configured to activate a timer upon the touch point entering a touch start state and detect, by the timer, the dwell touch duration during which the touch point stays at the same position.

In some embodiments of the present disclosure, the apparatus for identifying an operation provided by the present disclosure may further include a list sliding module configured to acquire, in response to the operation type of the touch operation being the slide operation acting on the virtual control list, a movement direction and a movement speed of the touch point, and slide the virtual control list according to the movement direction and the movement speed of the touch point.

In some embodiments of the present disclosure, the apparatus for identifying an operation provided by the present disclosure may further include an icon dragging module which may include a target icon determination unit and a drag icon updating unit.

The target icon determination unit is configured to acquire, in response to the operation type of the touch operation being the drag operation acting on the virtual control icon, a target virtual control icon corresponding to the drag operation.

The drag icon updating unit is configured to create a corresponding virtual control drag icon according to the target virtual control icon, and update a display position of the virtual control drag icon in real time according to a position of the touch point.

The specific details of each module/unit in the above apparatus for identifying an operation have been described in detail in the corresponding method embodiments, and will not be repeated here.

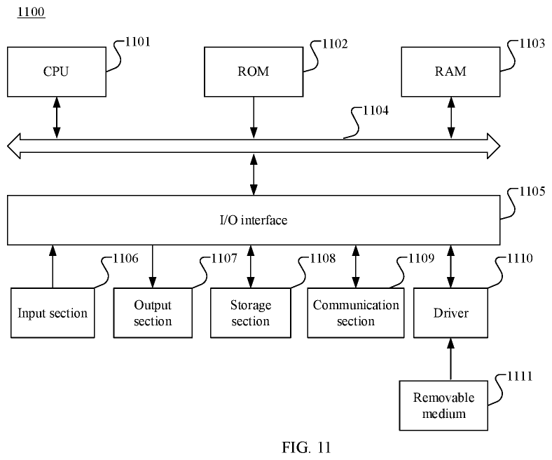

FIG. 11 shows a schematic structural diagram of a computer system of an electronic device applicable for implementing the embodiments of the present disclosure.

It should be noted that a computer system 1100 of the electronic device shown in FIG. 11 is only an example, and should not limit the functions and application scope of the embodiments of the present disclosure.

As shown in FIG. 11, the computer system 1100 includes a central processing unit (CPU) 1101 which can perform various appropriate actions and processes according to programs stored in a read-only memory (ROM) 1102 or loaded into a random access memory (RAM) 1103 from a storage section 1108. Various programs and data required for system operation are also stored in the RAM 1103. The CPU 1101, ROM 1102, and RAM 1103 are connected to each other via a bus 1104. An input/output (I/O) interface 1105 is also connected to the bus 1104.

The following components are connected to the I/O interface 1105: an input section 1106 including a keyboard, a mouse, etc.: an output section 1107 including a cathode ray tube (CRT), a liquid crystal display (LCD), and a speaker, etc.: the storage section 1108 including a hard disk, etc.: and a communication section 1109 including a network interface card such as a LAN card, a modem, or the like. The communication section 1109 performs communication processing via a network such as the Internet. A driver 1110 is also connected to the I/O interface 1105 as needed. A removable medium 1111 such as a magnetic disk, optical disk, magneto-optical disk, semiconductor memory, etc. is mounted on the driver 1110 as needed, so that a computer program read therefrom is installed into the storage section 1108 as needed.

In particular, according to an embodiment of the present disclosure, the processes described below with reference to the flowcharts can be implemented as computer software programs. For example, embodiments of the present disclosure provide a computer program product, which includes a computer program carried on a computer-readable medium, where the computer program includes program codes for executing the methods shown in the flowcharts. In such an embodiment, the computer program may be downloaded and installed from a network via the communication section 1109, and/or installed from the removable medium 1111. When the computer program is executed by the central processing unit (CPU) 1101, various functions defined in the system of the present disclosure are performed.

It should be noted that the computer-readable medium shown in the present disclosure may be a computer-readable signal medium or a computer-readable storage medium or any combination thereof. The computer-readable storage medium may be, for example, but not limited to, an electrical, magnetic, optical, electromagnetic, infrared, or semiconductor system, apparatus, or device, or any combination thereof. More specific examples of computer-readable storage medium may include, but are not limited to, electrical connections with one or more wires, portable computer diskettes, hard disks, random access memory (RAM), read-only memory (ROM), erasable programmable read-only memory (EPROM or flash memory), optical fiber, portable compact disk read-only memory (CD-ROM), optical storage device, magnetic storage device, or any suitable combination thereof. In the present disclosure, the computer-readable storage medium may be any tangible medium that contains or stores a program that can be used by or in conjunction with an instruction execution system, apparatus, or device. In the present disclosure, the computer-readable signal medium may include a data signal propagated in baseband or as part of a carrier wave, carrying computer-readable program code therein. Such propagated data signals may be in a variety forms, including, but not limited to, electromagnetic signals, optical signals, or any suitable combination thereof. The computer-readable signal medium may also be any computer-readable medium other than the computer-readable storage medium, and the computer-readable medium can send, propagate, or transmit a program for use by or in conjunction with an instruction execution system, apparatus, or device. The program code contained on the computer-readable medium may be transmitted using any appropriate medium, including, but not limited to: wireless, wire, optical cable, RF, etc., or any suitable combination thereof.

The flowchart and block diagrams in the drawings illustrate the architecture, functionality, and operation of possible implementations of systems, methods and computer program products according to various embodiments of the present disclosure. In this regard, each block in a flowchart or block diagram may represent a module, program segment, or portion of code that includes one or more executable instructions to perform a specific logical function. It should also be noted that, in some alternative implementations, the functions noted in the block may occur out of the order noted in the drawings. For example, two blocks shown in succession may, in fact, be executed substantially concurrently; or they may sometimes be executed in the reverse order, depending upon the functionality involved. It should also be noted that each block in the block diagrams or flowcharts, and combinations of blocks in the block diagrams or flowcharts, can be implemented by a dedicated hardware-based system that performs the specified function or operation, or can be implemented by a combination of dedicated hardware and computer instructions.

In another aspect, the present disclosure also provides a non-transitory computer-readable medium. The non-transitory computer-readable medium may be included in the electronic device described in the above-mentioned embodiments: or it may exist independently without being assembled into the electronic device. The above-mentioned computer-readable medium carries one or more programs, and when the above-mentioned one or more programs are executed by the electronic device, the electronic device implements the methods described in the above embodiments.

It should be noted that although several modules of the apparatus for action execution are mentioned in the above detailed description, these divisions are not mandatory. Actually, according to the embodiments of the present disclosure, the features and functions of two or more modules described above may be embodied in one module. Alternatively, the features and functions of one module described above may be further divided to be specified in more than one module.

Other embodiments of the present disclosure will be readily apparent to those skilled in the art from consideration of the specification and practice of the invention disclosed herein. The present disclosure is intended to cover any variations, uses, or adaptations of the present disclosure that follow the general principles of the present disclosure and include common knowledge or conventional technical means in the art not disclosed herein.

It should be understood that the present disclosure is not limited to the precise constructions which have been described above and shown in the drawings, and various modifications and changes may be made without departing from the scope thereof. The scope of the present disclosure is limited only by the appended claims.

1. A method for identifying an operation, comprising:
in response to a touch operation acting on a virtual control list in a graphical user interface, acquiring a state of a touch point corresponding to the touch operation, wherein the virtual control list comprises a draggable virtual control icon;
acquiring, upon the touch point being in a moving state, a movement angle of the touch point relative to a preset sliding direction of the virtual control list; and
determining whether the movement angle of the touch point is greater than a sliding angle threshold, and according to a result of determination of the movement angle, determining an operation type of the touch operation, wherein the operation type comprises a slide operation acting on the virtual control list, and a drag operation acting on the virtual control icon.

2. The method of claim 1, wherein determining the operation type of the touch operation according to the result of the determination of the movement angle comprises:
in response to determining that, the movement angle of the touch point is greater than the sliding angle threshold, determining the operation type of the touch operation as the drag operation acting on the virtual control icon; and
in response to determining that the movement angle of the touch point is less than or equal to the sliding angle threshold, acquiring a movement speed of the touch point, and identifying the operation type of the touch operation according to the movement speed of the touch point.

3. The method of claim 2, wherein acquiring the movement speed of the touch point comprises:
acquiring a movement duration from an initial time point when the touch point enters a touch start state to a current time point, and acquiring a movement distance of the touch point; and
obtaining, according to a ratio of the movement distance to the movement duration, the movement speed of the touch point at the current time point.

4. The method of claim 3, wherein acquiring the movement distance of the touch point comprises:
acquiring an initial position when the touch point enters the touch start state, and acquiring a current position of the touch point at the current time point; and
determining the movement distance of the touch point according to the initial position and the current position of the touch point.

5. The method of claim 2, wherein identifying the operation type of the touch operation according to the movement speed of the touch point comprises:
in response to determining that, the movement speed of the touch point is greater than or equal to a sliding speed threshold, determining the operation type of the touch operation as the slide operation acting on the virtual control list; and
in response to determining that the movement speed of the touch point is less than the sliding speed threshold, determining a dwell touch duration during which the touch point stays at a same position, and identifying the operation type of the touch operation according to the dwell touch duration.

6. The method of claim 5, wherein identifying the operation type of the touch operation according to the dwell touch duration comprises:
in response to determining that, the dwell touch duration is greater than or equal to a dwell duration threshold, determining the operation type of the touch operation as the drag operation acting on the virtual control icon; and
in response to determining that the dwell touch duration is less than the dwell duration threshold, acquiring a movement distance of the touch point, and determining whether the operation type of the touch operation is the slide operation acting on the virtual control list according to the movement distance.

7. The method of claim 5, wherein acquiring the dwell touch duration during which the touch point stays at the same position comprises:
activating a timer upon the touch point entering a touch start state and detecting, by the timer, the dwell touch duration during which the touch point stays at the same position.

8. The method of claim 1, further comprising:
in response to determining that the operation type of the touch operation is the slide operation acting on the virtual control list, acquiring a movement direction and a movement speed of the touch point, and controlling the virtual control list to slide according to the movement direction and the movement speed of the touch point.

9. The method of claim 1, further comprising:
in response to determining that the operation type of the touch operation is the drag operation acting on the virtual control icon, acquiring a target virtual control icon corresponding to the drag operation; and
creating a corresponding virtual control drag icon according to the target virtual control icon, and updating a display position of the virtual control drag icon in real time according to a position of the touch point.

10. (canceled)

11. An electronic device comprising:
a processor; and
memory configured to store one or more programs which, when executed by the processor, cause the processor to;
acquire, in response to a touch operation acting on a virtual control list in a graphical user interface, a state of a touch point corresponding to the touch operation, wherein the virtual control list comprises a draggable virtual control icon;
acquire, upon the touch point being in a moving state, a movement angle of the touch point relative to a preset sliding direction of the virtual control list; and
determine whether the movement angle of the touch point is greater than a sliding angle threshold, and according to a result of determination of the movement angle, determine an operation type of the touch operation, wherein the operation type comprises a slide operation acting on the virtual control list, and a drag operation acting on the virtual control icon.

12. A non-transitory computer-readable medium having stored thereon a computer program which, when executed by a processor, causes the processor to:
acquire, in response to a touch operation acting on a virtual control list in a graphical user interface, a state of a touch point corresponding to the touch operation, wherein the virtual control list comprises a draggable virtual control icon;
acquire, upon the touch point being in a moving state, a movement angle of the touch point relative to a preset sliding direction of the virtual control list; and
determine whether the movement angle of the touch point is greater than a sliding angle threshold, and according to a result of determination of the movement angle, determine an operation type of the touch operation, wherein the operation type comprises a slide operation acting on the virtual control list, and a drag operation acting on the virtual control icon.

13. The method of claim 6, wherein determining whether the operation type of the touch operation is the slide operation according to the movement distance comprises:
in response to determining that the movement distance is greater than a preset distance threshold, determining that the operation type of the touch operation is the slide operation.

14. The electronic device of claim 11, wherein the processor is further configured to:
determine, in response to determining that the movement angle of the touch point is greater than the sliding angle threshold, the operation type of the touch operation as the drag operation acting on the virtual control icon; and
acquire, in response to determining that the movement angle of the touch point is less than or equal to the sliding angle threshold, a movement speed of the touch point, and identify the operation type of the touch operation according to the movement speed of the touch point.

15. The electronic device of claim 14, wherein the processor is further configured to:
acquire a movement duration from an initial time point when the touch point enters a touch start state to a current time point, and acquire a movement distance of the touch point; and
obtain, according to a ratio of the movement distance to the movement duration, the movement speed of the touch point at the current time point.

16. The electronic device of claim 15, wherein the processor is further configured to:
acquire an initial position when the touch point enters the touch start state, and acquire a current position of the touch point at the current time point; and
determine the movement distance of the touch point according to the initial position and the current position of the touch point.

17. The electronic device of claim 14, wherein the processor is further configured to:
determine, in response to determining that the movement speed of the touch point is greater than or equal to a sliding speed threshold, the operation type of the touch operation as the slide operation acting on the virtual control list; and
determine, in response to determining that the movement speed of the touch point is less than the sliding speed threshold, a dwell touch duration during which the touch point stays at a same position, and identify the operation type of the touch operation according to the dwell touch duration.

18. The electronic device of claim 17, wherein the processor is further configured to:
determine, in response to determining that the dwell touch duration is greater than or equal to a dwell duration threshold, the operation type of the touch operation as the drag operation acting on the virtual control icon; and
acquire, in response to determining that the dwell touch duration is less than the dwell duration threshold, a movement distance of the touch point, and determine whether the operation type of the touch operation is the slide operation acting on the virtual control list according to the movement distance.

19. The electronic device of claim 17, wherein the processor is further configured to:
activate a timer upon the touch point entering a touch start state and detect, by the timer, the dwell touch duration during which the touch point stays at the same position.

20. The non-transitory computer-readable medium of claim 12, wherein the processor is further configured to:
acquire, in response to determining that the operation type of the touch operation is the slide operation acting on the virtual control list, a movement direction and a movement speed of the touch point, and control the virtual control list to slide according to the movement direction and the movement speed of the touch point.

21. The non-transitory computer-readable medium of claim 12, wherein the processor is further configured to:
acquire, in response to determining that the operation type of the touch operation is the drag operation acting on the virtual control icon, a target virtual control icon corresponding to the drag operation; and
create a corresponding virtual control drag icon according to the target virtual control icon, and update a display position of the virtual control drag icon in real time according to a position of the touch point.
